(19) United States
(12) Patent Application Publication
(10) Pub. No.: US 2002/0082050 A1
(43) Pub. Date: Jun. 27, 2002

(54) Operations, administration and maintenance of components in a mobility network

(75) Inventors: Scott Mountney, Redmond, WA (US); Mike Verstegen, Redmond, WA (US); Hong Zhao, Redmond, WA (US)

Correspondence Address: One World Trade Center, Suite 1600, 121 S.W. Salmon Street, Portland, OR, 97204, US

(73) Assignee: AT&T Wireless Services, Inc.

(21) Appl. No.: 09/991,549

(22) Filed: Nov. 15, 2001

Related U.S. Application Data
(60) Provisional application No. 60/248,978, filed on Nov. 15, 2000.

(51) Int. Cl. H04B 1/38

(52) U.S. Cl. 455/560; 455/7

(57) ABSTRACT

The present application relates to a technique for more efficiently performing operations, administrative and maintenance (OA&M) on components in a mobility network. In one aspect, the need for a dedicated channel or resource to perform such operations on system components, is eliminated. For example, in the case of repeaters, the existing control channel is used for performing OA&M. Additionally, address information is put into the message on the control channel to uniquely communicate with desired system components.

### RELATED APPLICATION DATA

This application claims priority to provisional application 60/248,978 filed Nov. 15, 2000, and titled “Over the air repeater common shared channel based OA&M (operations, administration, and maintenance).”

### FIELD OF THE INVENTION

The present application relates generally to components, such as repeaters, in a mobility network and, more particularly, to a technique for performing operations, administration, and maintenance of such components.

### BACKGROUND

FIG. 1 shows a prior art mobility network or cellular telephone system 10 for mobile communications. The system 10 includes a control center 12, a mobile switching center (MCS) 14, a base station controller (BSC) 16, and multiple base transceiver stations (BTS) 18, 20, 22, also called base stations or cells. The control center 12 is for controlling the network 10 and for monitoring performance of the other network components, as further described below. The MCS allows for communication to other networks, such as the PSTN, ISDN and other data networks. The BSC is one of many in a base station subsystem (other BSCs not shown) and controls multiple of BTSs. Each BTS is coupled to a communication tower or antenna 24 for transmitting and receiving signals from mobile stations (e.g., a cellular phone), such as mobile station 26. The towers are strategically placed on buildings or along roadways in high-traffic areas.

One of the base stations is typically designated as a donor cell and is coupled to multiple repeaters. In the case of FIG. 1, the donor cell is shown as BTS 20 and is coupled to repeaters 30, 32, and 34, by means of cable or wireless means. Repeaters are an economical alternative to expand coverage area while minimizing the number of towers. Specifically, repeaters are small electronic devices used to boost and amplify transmitted and received signals that have weakened because the signal has decayed over distance. Repeaters may also be used to retransmit signals in segments of roads that signals cannot otherwise penetrate, such as in tunnels. Repeaters generally only have sufficient power to cover short distances (e.g., 100 meters) and are often coupled to directional antennas, such as shown at 36. However, repeaters also may be coupled to other communication towers, as shown at 38.

The control center 12 periodically polls the components on the system 10 to ensure that all of the components are operating properly. For example, the components may be checked to determine whether they are on or off and whether they are working properly. There are a variety of reasons that the controller may check the components and such reasons are generally termed in the art as operations, administrative and maintenance operations. In the case of obtaining performance information from the repeaters, the controller sends the request through the donor BTS 20. The repeaters are coupled to the BTS using dedicated traffic channels, shown at 40, and a separate channel or wire 42 for polling to obtain or perform administrative operations, alarm monitoring, control, maintenance, and diagnostic procedures (collectively called operations, administration and maintainance (OA&M)). This operational or diagnostic information is transferred through the network to the control center for analysis.

A problem exists with the current connection scheme in that having a dedicated channel or wire to connect to the repeaters or other system components is costly. For example, some repeaters in the field have a separate twisted pair wire (42) that is plugged into the repeater for direct communication to the repeater. The cost of running a separate line for each repeater is high and increases the likely of failure due to a wire breaking or other connection problems.

Therefore a need exists for a more efficient technique for obtaining or performing operations, administrative and maintenance on components in a mobility network.

### SUMMARY

The present application relates to a technique for more efficiently performing operations, administrative and maintenance (OA&M) on components in a mobility network. Specifically, the present invention eliminates the need for a dedicated channel or resource to perform such operations on system components. For example, in the case of repeaters, the existing control channel is used for performing OA&M. Additionally, address information is put into the message on the control channel to uniquely communicate with desired system components.

The foregoing and other aspects of the invention will become apparent from the following detailed description of an exemplary embodiment that proceeds with reference to the following drawings.

### BRIEF DESCRIPTION OF DRAWINGS

FIG. 1 is a prior art mobility system having a dedicated line for performing OA&M on system components.

FIG. 2 is a diagram illustrating a mobility system according to the invention that uses a control channel to perform OA&M on system components.

FIG. 3 is a flowchart of a method for performing OA&M on system components in a mobility network.

### DETAILED DESCRIPTION

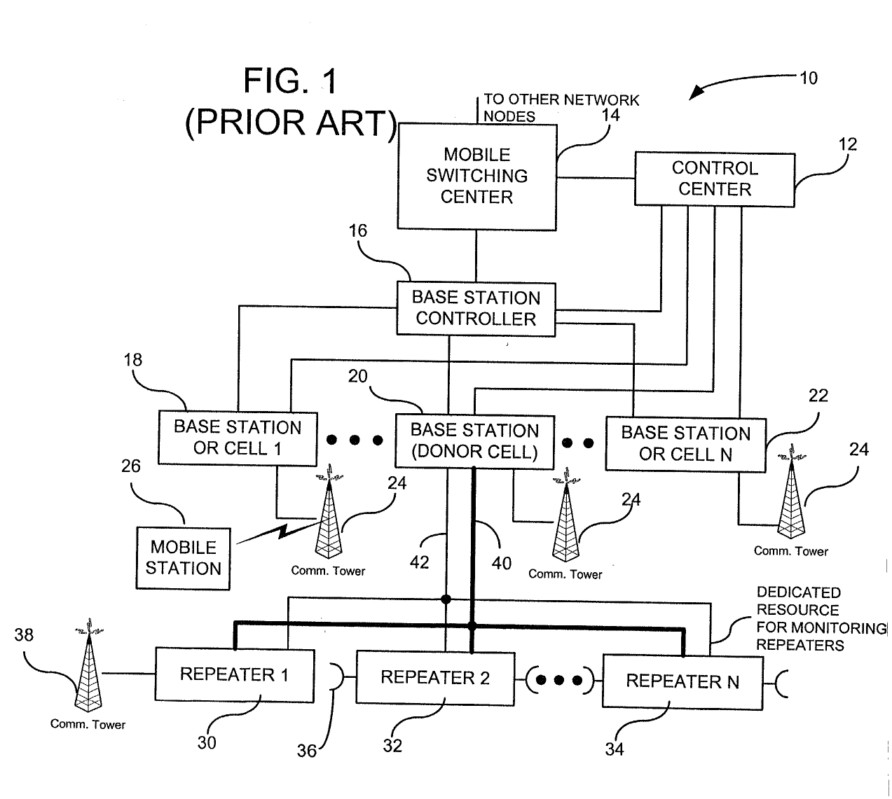

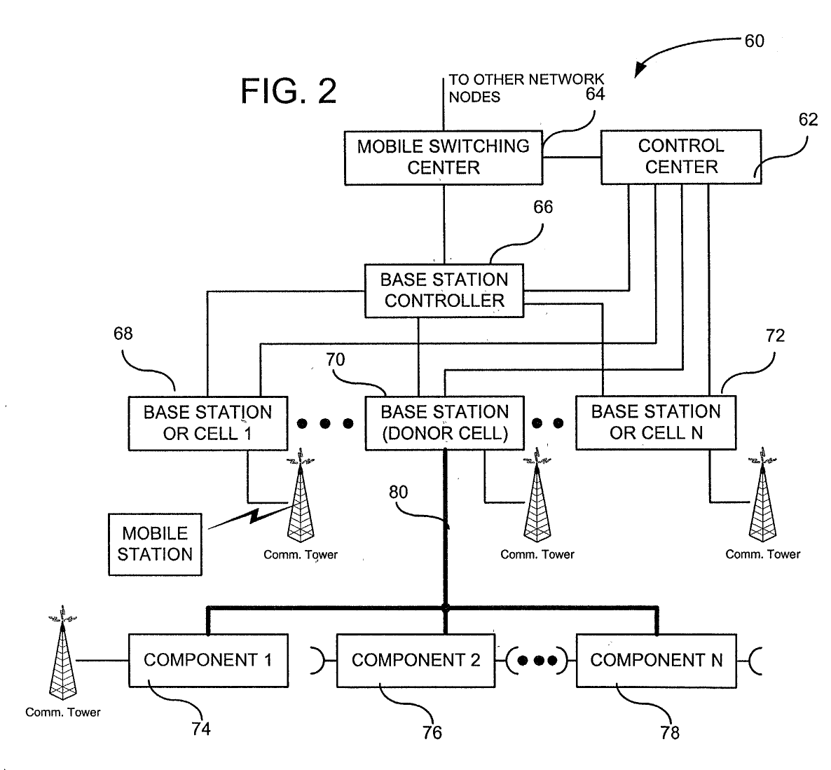

FIG. 2 shows a system 60 according to the invention. The system 60 includes a control center 62, a mobile switching center 64, a base station controller 66, and multiple base stations 68, 70 and 72, which are all connected as previously described. The mobile switching center, base station controller, and base stations collectively form a mobile network. Multiple system components 74, 76 and 78, are coupled to the donor cell (base station) 70 through communication channel 80. The communication channel 80 may be a cable, such as a coaxial cable or fiber-optic cable, or may be a wireless connection scheme. Notably, unlike in FIG. 1, no additional resources (such as dedicated channel 42 from FIG. 1) are needed to communicate with the components 74, 76 and 78. It should be noted that the components 74, 76 and 78 may be repeaters or any third-party components, such as smart antennas.

The base station 70 includes many radio channels for communicating with other components. For example, the base station includes traffic channels and a common control channel. Typically, when a phone call is initiated, the control channel is created to set up links between the telephones that are parties to the call. Additionally, the control channel initiates the ringing of the requested phone or mobile station. Once the call is properly set up, the control channel is torn down and the traffic channels for communication are established. It is this control channel that is used to perform OA&M on system components 74, 76 and 78.

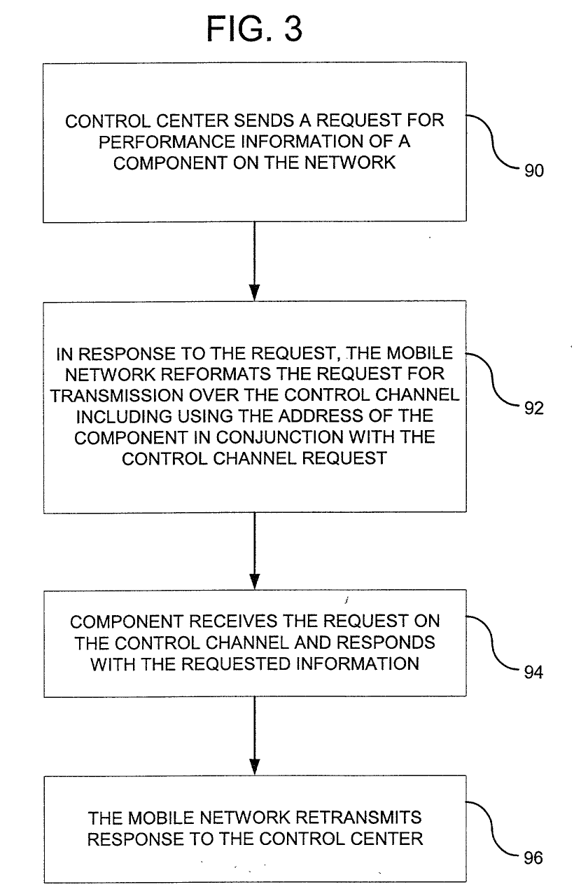

FIG. 3 shows a flowchart of a method for implementing the OA&M on a system component. A specific example of requesting performance information is discussed by other communications may occur, such as those involving OA&M. In process block 90, the control center sends a request for performance information of a component on the network. For example, the control center 62 may wish to poll or request the component 74 to send the information at periodic intervals to ensure that it is properly operating. To accomplish this, the control center 62 sends the request to the mobile network. In a particular example, the request may be sent to the base station controller 66 within the base station subsystem.

As shown in process block 92, in response to the request, the mobile network reformats the request for transmission over the digital control channel (DCH). To accomplish this, the mobile network includes address information of the component into the request on the control channel. In a particular example, the base station controller inserts the address information and puts the request on the digital control channel. The request is then forwarded to the donor cell base station 70 and retransmitted to the component.

In process box 94, the component receives the request on the control channel and responds with the requested information. Typically, in responding to the request, the component puts its own address information first followed by a data, such as status.

In process box 96, the mobile network forwards the requested information on to the control center 62. In a particular example, the requested information is received by the base station controller and resent to the control center.

Thus, in sum, the system provides all over-the-air repeater administration, alarm monitoring, operations and element control with connectivity specifically residing on a repeater's donor cell common shared channel resource (traffic or control) and passed between subsequent repeaters on the repeater simulcast common shared channel resource. In the event that a string of “daisy chained” repeaters are used, the OA&M connectivity to subsequent repeaters in any type of simulcast or series configuration will continually reside on the common shared channel resource.

The invention takes advantage of the common shared channel transport ability of the wireless network to establish a connection to the control center over the network that is being repeated without taking away capacity from the traffic.

Competitive consumer electronics level pricing will quickly be established for compatible transceivers so that this telemetry information transport can be added very easily and inexpensively to these repeaters. As long as the donor site is operating, a “heartbeat” can be obtained from the repeater, assuring that it is still operating. In addition, detailed operating measurements and reports, as well as instructions (e.g., change parameters or settings) and controls, can be sent over the same administration link.

Note that this technique is equally applicable to all fixed and mobile wireless networks with common shared channel or repeater donor channel resources, such as GSMK-GPRS, EDGE-GPRS, CDPD, CDMA, W-CDMA, etc.

Having illustrated and described the principles of the illustrated embodiments, it will be apparent to those skilled in the art that the embodiments can be modified in arrangement and detail without departing from such principles.

Although the figures focused on traffic channels for voice communication, the invention is equally applicable to data channels, such as the data channel in EDGE-GPRS, which would also use a data control channel.

Additionally, although the control channel is generally used to carry the OA&M information, other channels that are already used for communication with the mobile stations also may be used, such as the traffic channels and channels that are broadcast to the receivers.

In view of the many possible embodiments, it will be recognized that the illustrated embodiments include only examples of the invention and should not be taken as a limitation on the scope of the invention. Rather, the invention is defined by the following claims. We therefore claim as the invention all such embodiments that come within the scope of these claims.

We claim:

1. A method for communicating between a control center and components in a mobility network, comprising:
from a control center, determining a component on the mobility network to perform an operation on or request information from; and
using a control channel to communicate with the component to perform the operation or to request the information.

2. The method of claim 1, wherein the component is a repeater.

3. The method of claim 1, further including inserting address information of the component into a message sent to the component to perform the operation or to request the information.

4. An apparatus for communicating between a control center and components in a mobility network, comprising:
a control center;
a mobile network coupled to the control center;
multiple components coupled to the mobile network through communication channels; and
wherein the control center can communicate with one or more of the multiple components by using the communication channels.

5. The apparatus of claim 4, wherein the communication channels includes a control channel.

6. The apparatus of claim 4, wherein the components are repeaters.

7. The apparatus of claim 4, wherein the communication channels are used for communicating information from sources other than the control center.

8. The apparatus of claim 4, wherein the mobile network includes a mobile switching center, a base station controller, and multiple base stations.

9. The apparatus of claim 4, wherein the communication channels consist of a broadcast channel that broadcast information to multiple components simultaneously.

10. The apparatus of claim 9, wherein the broadcast channel includes a control channel and traffic channels.

11. An apparatus for communicating between a control center and components in a mobility network, comprising:
means for monitoring multiple repeaters in the mobility network; and
means for transmitting information between the repeaters and the means for monitoring using broadcast channels.

12. The apparatus of claim 11, wherein the means for transmitting includes inserting a repeater address into a message on the broadcast channel to address a desired repeater.

13. The apparatus of claim 11, wherein the broadcast channels include a control channel.

14. An apparatus for communicating between a control center and components in a mobility network, comprising
a control center;
a base station controller coupled to the control center;
a donor base station coupled to the base station controller;
multiple repeaters coupled in parallel to the donor base station, the coupling including multiple broadcast channels;
wherein communications between the control center and the repeaters occurs by using a repeater address in association with a message on one of the broadcast channels.

15. The apparatus of claim 14, wherein the broadcast channel consists of a control channel.
